(19) United States
(12) Patent Application Publication
(10) Pub. No.: US 2007/0094400 A1
(43) Pub. Date: Apr. 26, 2007

(54) Software installation within a federation

(76) Inventors: Rhonda L. Childress, Austin, TX (US); David Bruce Kumhyr, Austin, TX (US); Neil Pennell, Creek, TX (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/254,750

(22) Filed: Oct. 20, 2005

(51) Int. Cl. G06F 15/16

(52) U.S. Cl. 709/229

(57) ABSTRACT

Methods, apparatuses, and computer program products are provided for software installation within a federation. Embodiments include receiving, by an installation administration proxy server from a user agent installed on a user computer, an install request; validating, by the installation administration proxy server, the install request including validating a security token associated with the install request and identifying, by the installation administration proxy server, a trusted software installation server to install software associated with the install request on the user computer. The installation administration proxy server, the user agent, and the trusted software installation server comprise entities in the federation. Typical embodiments also include installing, by the trusted software installation server, software on the user computer in accordance with software installation rules.

### BACKGROUND OF THE INVENTION

1. Field of the Invention

The field of the invention is data processing, or, more specifically, methods, apparatuses, and products for software installation within a federation.

2. Description of Related Art

Often large organizations maintain remote offices with little or no support staff for software installation on the computers of those entities. Such a lack of support staff makes software code that is too large to fit on a single compact disc difficult to distribute to remote offices and also makes updating the software challenging. Furthermore, relying on other organizations to remotely perform software installation is challenging because different organizations often implement different security protocols. There is an ongoing need for a method for software installation capable of operation in a distributed environment across different security realms.

### SUMMARY OF THE INVENTION

Methods, apparatuses, and computer program products are provided for software installation within a federation. Embodiments include receiving, by an installation administration proxy server from a user agent installed on a user computer, an install request; validating, by the installation administration proxy server, the install request including validating a security token associated with the install request; and identifying, by the installation administration proxy server, a trusted software installation server to install software associated with the install request on the user computer. The installation administration proxy server, the user agent, and the trusted software installation server comprise entities in the federation. Typical embodiments also include installing, by the trusted software installation server, software on the user computer in accordance with software installation rules.

Validating, by the installation administration proxy server, the install request may be carried out by verifying a network location for the user agent. Identifying, by the installation administration proxy server, a trusted software installation server may be carried out by identifying a software installation server outside the security realm of the installation administration proxy server and providing, by the software administration proxy server to the software installation server outside the security realm of the installation administration proxy server, a proxy install request including a security token.

Embodiments may include validating, by the software installation server outside the security realm of the installation administration proxy server, the proxy install request; and installing, by the software installation server outside the security realm of the installation administration proxy server, software on user computer in dependence upon software installation rules. Embodiments may also include validating, by the software installation server outside the security realm of the installation administration proxy server, the proxy install request; providing, to installation administration proxy server by the software installation server outside the security realm of the installation administration proxy server, software installation rules; and installing, by the installation administration proxy server, software associated with the install request on user computer in dependence upon the software installation rules.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram illustrating an exemplary system for software installation within a federation according to embodiments of the present invention.

FIG. 2 sets forth a block diagram of automated computing machinery comprising an exemplary installation administration server useful in software installation within a federation according to embodiments of the present invention.

FIG. 3 sets forth an exemplary method for software installation within a federation.

FIG. 4 sets forth a flow chart illustrating an exemplary method for validating an install request.

FIG. 5 sets forth an example of software installation within a federation according to embodiments of the present invention that includes identifying a software installation server outside the security realm of the installation administration proxy server.

FIG. 6 sets forth a flow chart illustrating another exemplary method for software installation within a federation according to embodiments of the present invention wherein the software installation server does not install the software, but instead, provides software installation rules to the installation administration proxy server to carry out the installation of the software.

### DETAILED DESCRIPTION OF EXEMPLARY EMBODIMENTS

### Software Installation within a Federation

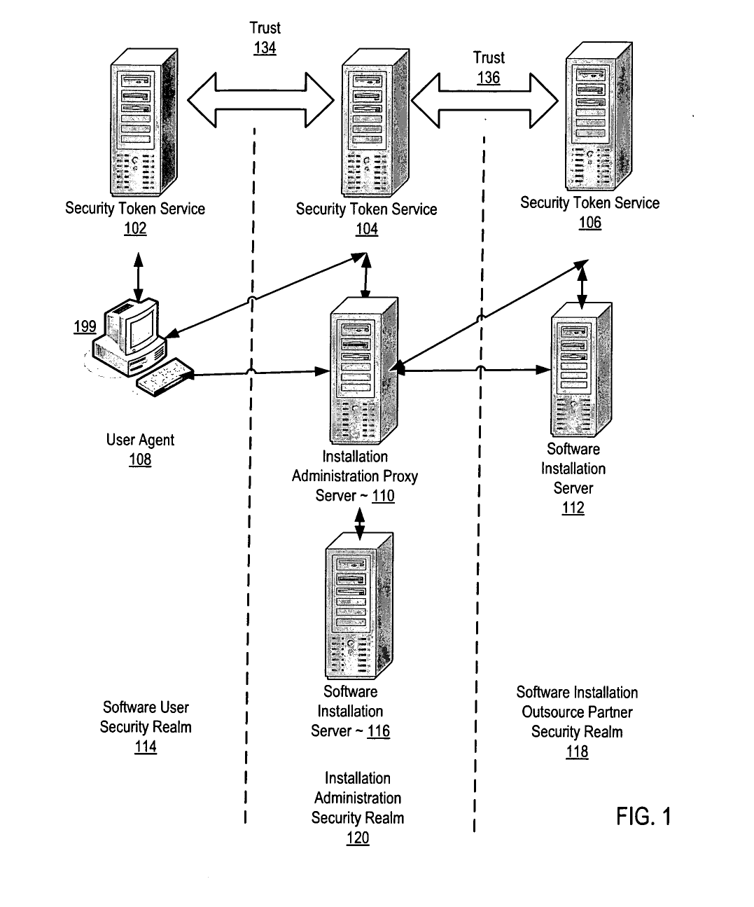

Exemplary methods, apparatuses, and products for software installation within a federation according to embodiments of the present invention are described with reference to the accompanying drawings, beginning with FIG. 1. FIG. 1 sets forth a block diagram illustrating an exemplary system for software installation within a federation according to embodiments of the present invention. A federation is a collection of entities each representing a single unit of security administration and each having established trust with at least one other entity in the federation. Trust is the characteristic that one entity within the federation is willing to rely upon another entity in the federation to execute one or more actions on the entity's behalf. Trust is administered within a federation by establishing security credentials that satisfy the relevant security policies of respective entities within the federation. Trust may be direct between a first entity and a second entity. Trust may also be indirect between a first entity and a third entity wherein the third entity relies on a trusted second entity vouch for the first entity. That is, a third entity trusts the first entity because the first entity has satisfied the security protocols of the second entity.

The Web Services Federation Language (‘WS-Federation’) defines mechanisms for brokering trust among entities within a federation for use with Web services and application-specific protocols. WS-Federation accommodates a wide variety of security models. The Web Services Federation Language Specification is available for download at http://www.ibm.com/developerworks/library/ws-fed/.

The exemplary federation of FIG. 1 includes three trust realms, a software user realm (114), an installation administration realm (120), and a software installation outsource partner realm (118). A trust realm is an administered security space in which the sources and targets of requests determine and agree upon particular sets of credentials that satisfy the relevant security policies of the trust realm. Entities within each of the trust realms (114, 120, and 118) of FIG. 1 may use different security protocols within their respective trust realm, but may still request and execute actions on behalf of entities in other trust realms of FIG. 1 by brokering trust according to WS-Federation.

The software user realm (114) is an administered security space including computers on which software is installed according to embodiments of the present invention. In the example of FIG. 1, the software user realm (114) includes a user agent (108) installed upon a user computer (199). A user computer according to the example of FIG. 1 is an entity in the federation upon which software is installed according to embodiments of the present invention.

A user agent (108) in the example of FIG. 1 is implemented as software that initiates software installation according to embodiments of the present invention by sending an install request to the installation administration proxy server (110) located at a well known universal resource locator (‘URL’). The installation administration proxy server (110) in the example of FIG. 1 is an entity in the federation that receives install requests from user agents, validates those install requests, and identifies a software installation server for software installation on the user computer (199).

The software user realm (114) also includes a security token service (102) that has established trust (134) with the security token service (104) of the installation administration realm. A security token service is typically a Web service that issues security tokens to broker trust between entities in different security realms of the federation. To communicate trust, a security token service requires proof, such as a security token or set of security tokens, and issues a security token with its own trust statement.

The example of FIG. 1 also includes an installation administration realm (120) that is a security realm in the federation that includes an installation administration proxy server (110), a security token service (104) and a software installation server (116). The installation administration proxy server (110) in the example of FIG. 1 is an entity in the federation that receives install requests from user agents, validates those install requests, and identifies a software installation server for software installation on the user computer (199). In the example of FIG. 1, the software installation server may reside in the same security realm (120) as the installation administration proxy server (110).

The software installation server (112) may alternatively reside in a different security realm than the installation administration proxy server. In the example of FIG. 1, another software installation server (112) resides in a software installation outsource partner realm (118). The software installation outsource partner realm is an administered security space of a software installation server that installs software on the client computer (199) under an outsourcing relationship with the operator of the installation administration proxy server.

The exemplary system of FIG. 1 operates to perform software installation within a federation according to embodiments of the present invention generally by receiving, in an installation administration proxy server (110) from a user agent (108) installed on a user computer (199), an install request. An install request is message representing a request for software installation on a user computer (199). An install request may comprise a request for software code to be installed on the user computer (199). An install request may also comprise a request for a password enabling the installation of software already available to the client computer, a request for a software upgrade, or any other install request or combination of install requests that will occur to those of skill in the art.

The install request also includes a security token used to broker trust between the software user security realm (114) and the installation administration security realm (120). WS-Federation provides for the use of security tokens to validate entities within the federation. A security token is typically implemented as an extension to a Simple Object Access Protocol (‘SOAP’) message and represents a collection of claims, which are declarations made by the entity providing the security token. Examples of claims often included in a security token are the entity name, identity of entity issuing the security token, privileges of the entity providing the token, capabilities of the entity providing the token, as well as others that will occur to those of skill in the art. Security tokens can include credentials generated by the security apparatuses associated with respective entities in the overall federation.

As just discussed above, security tokens useful in the example of FIG. 1 are often embedded in Simple Object Access Protocol (‘SOAP’) message. SOAP provides XML-based message exchange paradigm for exchanging structured and typed information between peers in a decentralized, distributed environment. SOAP is a stateless, one-way message exchange paradigm, but may be useful in more complex request/response interaction patterns by combining these one-way exchanges with features provided by another protocol or application-specific information.

The exemplary installation administration proxy server (110) of FIG. 1 validates the install request by validating a security token associated with the install request. Validating a security token provided by the user agent may be carried out by use of one or more security token services in accordance with the WS-Federation. One way an installation administration proxy server validates the install request is carried out by receiving a security token for the installation administration realm (120) provided by the user agent. In such embodiments, a user agent (108) may receive the security token for the installation administration security realm (120) from a security token service (102) in the software user security realm (114) that has established trust with a security token service (104) for the installation administration security realm (120) or from the security token service (104) of the installation administration security realm (120).

A user agent may receive a security token acceptable in the installation administration realm (120) from a security token service (102) in the software user security domain (114) that has established trust (134) with a security token service (104) for the installation administration security realm (120). Alternatively, a user agent may receive a security token acceptable in the installation administration realm (120) from a security token service (104) in the installation administration security realm (120) that has established trust with a security token service (102) in the software user security domain (114). In such embodiments, a user agent may receive a security token acceptable in the installation administration realm (120) by presenting a security token for the software user realm (114) to the security token service (104) in the installation administration security realm (120) and receiving from the security token service (104) for the installation administration realm (114) an acceptable security token.

Another way the installation administration proxy server (110) may validate an install request may be carried out by receiving a security token for the software user realm (114) and presenting the security token for the software user realm (114) to a security token service (104) for the installation administration realm (120) that has established trust with a security token service (102) in the software user realm. In exchange for the security token presented by the user agent (108), the installation administration proxy server (110) receives a security token for the installation administration realm (120).

The examples of validating an install request including a security token provided by the user agent described above are for explanation and not for limitation. In fact, Web Services Federation Language provides a number of ways of validating a security token and all such ways, as well as others that will occur to those of skill in the art.

Software installation according to the example of FIG. 1 proceeds by identifying, by the installation administration proxy server (110), a trusted software installation server to install software associated with the install request on the user computer. A trusted software installation server is a server capable of installing software according to embodiments of the present invention that is trusted within the federation. In the example of FIG. 1, one trusted software installation server (116) resides within the installation administration realm (120) and another trusted software installation server (112) resides in the software installation outsource partner security realm (118).

In embodiments where the trusted software installation server (112) resides outside the security realm (120) of the installation administration proxy server (110), to broker trust, the software administration proxy server (110) provides to the software installation server outside the security realm (120) of the installation administration proxy server, a proxy install request including a security token. The software installation server (112) may then validate the proxy install request in one of a number of ways. As discussed above, validating a proxy install request including a security token may be carried out by receiving a security token for the software installation outsource partner realm (118) from the installation administration proxy server (110) who receives the security token from a security token service (104) in the installation administration realm (120) or from a security token service (106) in the software installation outsource partner realm (118), wherein the security token services (104, 106) have established trust (136). Another way the software installation server (112) may validate the proxy install request may be carried out by receiving a security token for the installation administration realm (120) and presenting the security token for the installation administration realm (120) to a security token service (106) for the software installation outsource partner realm (118) and receiving in exchange a security token for the software installation outsource partner security realm.

The identified software installation server installs software on the user computer (199) according to one or more software installation rules. Software installation rules are rules governing the installation of software for the user computer that are implemented by the software installation server that performs the software installation. Software installation rules are typically negotiated between the operator of entity of the federation that carries out the software installation and the operator of the user computer. Examples of software installation rules include rules instructing the software installation server to provide to a requesting user agent actual code for installation on the client computer, rules instructing the software installation server to provide to the client computer a password enabling the installation of code already available to a requesting user agent on the client computer, rules instructing the software installation server to provide a software upgrade to the requesting user agent on the client computer, and other rules that will occur to those of skill in the art.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP/IP, HTTP, WAP, HDTP, and others as will occur to those of skill in the art. Various embodiments of the present invention may be implemented on a variety of hardware platforms in addition to those illustrated in FIG. 1.

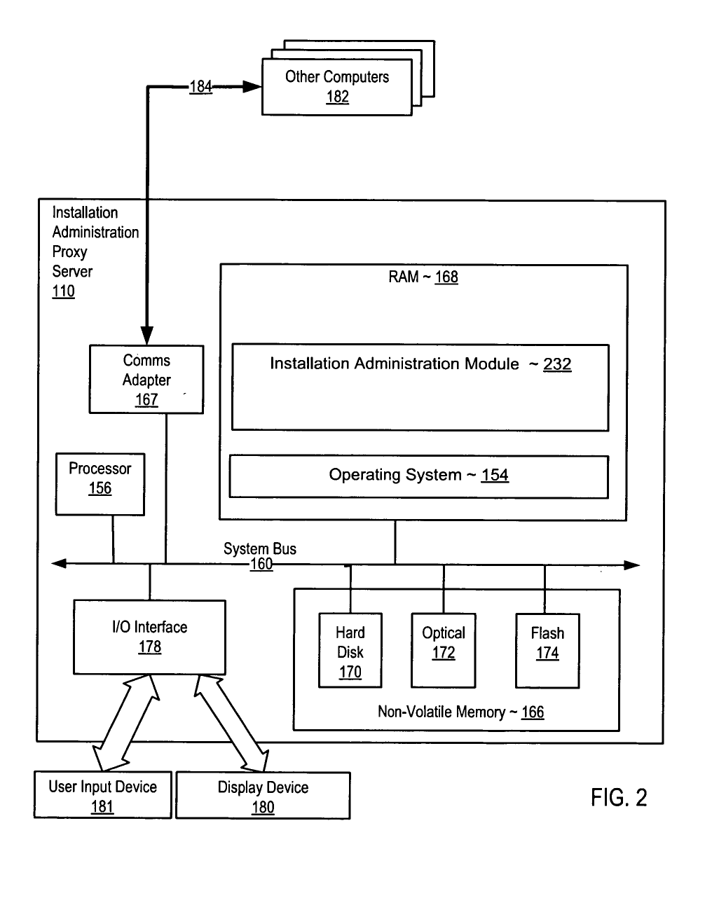

As discussed above, software installation within a federation in accordance with the present invention is generally implemented with computers, that is, with automated computing machinery. In the system of FIG. 1, for example, all the nodes, servers, and communications devices are implemented to some extent at least as computers. For further explanation, therefore, FIG. 2 sets forth a block diagram of automated computing machinery comprising an exemplary installation administration server (110) useful in software installation within a federation according to embodiments of the present invention. The installation administration server (110) of FIG. 2 includes at least one computer processor (156) or ‘CPU’ as well as random access memory (168) (“RAM”) which is connected through a system bus (160) to processor (156) and to other components of the installation administration server.

Stored in RAM (168) is an installation administration module (232) comprising computer program instructions for software installation within a federation according to embodiments of the present invention. The installation administration module (232) of FIG. 2 is capable of receiving an install request from a user agent, validating the install request including validating a security token associated with the install request, and identifying a trusted software installation server to install software associated with the install request on the user computer.

Also stored in RAM (168) is an operating system (154). Operating systems useful in computers according to embodiments of the present invention include UNIX™, Linux™, Microsoft Windows XP™, AIX™, IBM's i5/OS™, and others as will occur to those of skill in the art. Operating system (154), an installation administration module (232) in the example of FIG. 2 are shown in RAM (168), but many components of such software typically are stored in non-volatile memory (166) also.

The exemplary installation administration server (110) of FIG. 2 includes non-volatile computer memory (166) coupled through a system bus (160) to processor (156) and to other components of the installation administration server (110). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The exemplary installation administration server of FIG. 2 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The installation administration server (110) of FIG. 2 includes a communications adapter (167) for implementing data communications (184) with other computers (182). Such data communications may be carried out serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful for software installation within a federation according to embodiments of the present invention include modems for wired dial-up communications, Ethernet (IEEE 802.3) adapters for wired network communications, and 802.11b adapters for wireless network communications.

FIG. 2 sets forth a block diagram of an exemplary installation administration server. Other computers useful in software installation within a federation according to embodiments of the present invention may be configured similarly, but with other software modules resident.

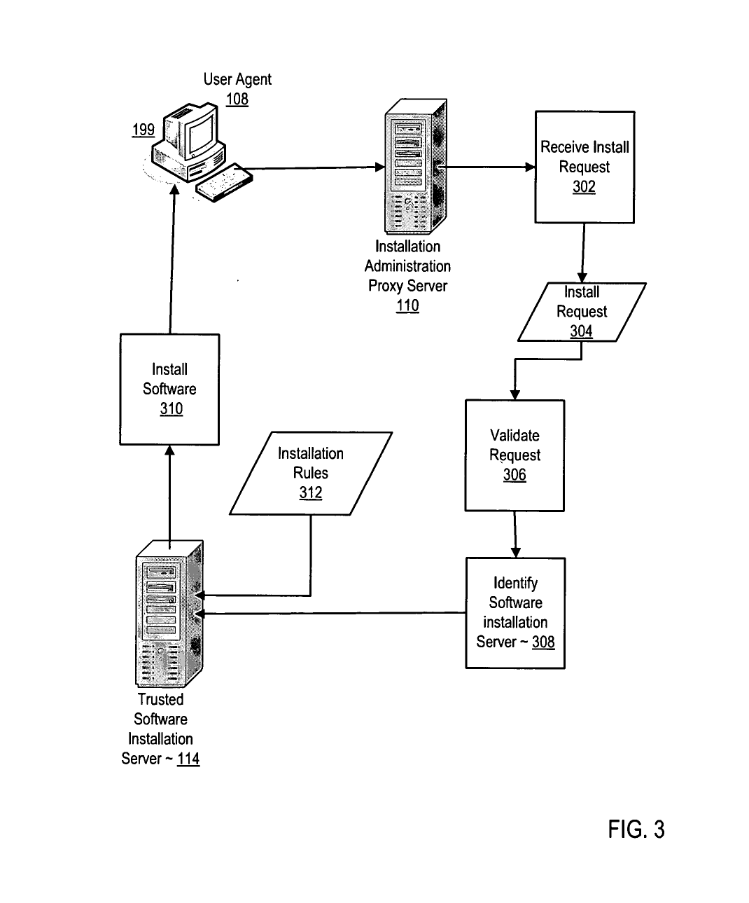

For further explanation, FIG. 3 sets forth an exemplary method for software installation within a federation that includes receiving (302), by an installation administration proxy server (110) from a user agent (108) installed on a user computer (199), an install request (304). As discussed above, the installation administration proxy server (110) and the user agent (108) in the example of FIG. 3 comprise entities within a federation. The installation administration proxy sever (110) and the user agent (108) may reside in different security realms that use different security protocols. The installation administration proxy sever (110) may however administer software installation for the user agent through trust brokered according to, for example, WS-Federation Language.

As discussed above, an install request is message representing a request for software installation on a user computer (199). An install request (304) may comprise a request for software code to be installed on the user computer (199). An install request may also comprise a request for a password enabling the installation of software already available to the client computer, a request for a software upgrade, or any other install request or combination of install requests that will occur to those of skill in the art.

In the example of FIG. 3, a user agent (108) sends an install request to the installation administration proxy server (110) at a pre-designated URL for install requests. Providing a pre-designated URL for install requests allows user agents to be preconfigured to send all install requests to the pre-designated URL regardless of which user computer requires software installation.

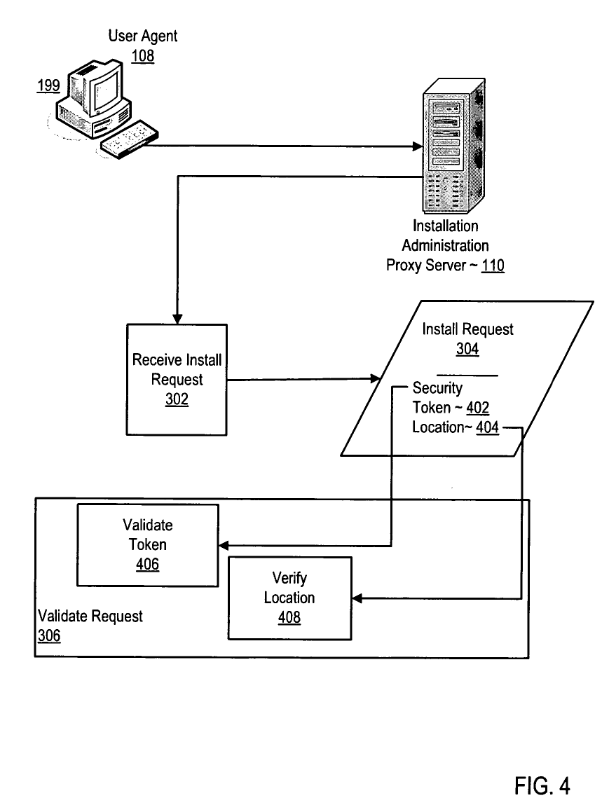

The method of FIG. 3 also includes validating (306), by the installation administration proxy server (110), the install request (306). For further explanation, FIG. 4 sets forth a flow chart illustrating an exemplary method for validating (306), by the installation administration proxy server (110), an install request (304). The method of FIG. 4 includes validating (406) a security token (402) associated with the install request (304). As discussed above, WS-Federation provides for the use of security tokens to validate entities within the federation. A security token is typically implemented as an extension to a Simple Object Access Protocol (‘SOAP’) message and represents a collection of claims, which are declarations made by the entity providing the security token. Examples of claims often included in a security token include the entity name, identity of entity issuing the security token, privileges of the entity providing the token, capabilities of the entity providing the token, as well as others that will occur to those of skill in the art.

The exemplary installation administration proxy server (110) of FIG. 4 validates the install request by validating a security token associated with the install request. Validating a security token provided by the user agent may be carried out by use of one or more security token services in accordance with the WS-Federation as discussed in more detail above with reference to FIG. 1.

The method of FIG. 4 also includes verifying (408) a network location (404) for the user agent (108). In the example of FIG. 4 the install request (304) also includes a network location for the user agent. One way of verifying (408) the location (404) of the user agent (108) may be carried out by comparing a uniform resource locator (‘URL’) provided by the user agent with a list of acceptable URLs for the user agents available to installation administration proxy server. If the URL provided by the user agent is included within the list of acceptable URLs for the user, then the installation administration proxy server will identify a software installation server to carry out the install request. Verifying the network location for the user agent provides an additional security feature by requiring that the user agent not only be trusted as evidenced by a security token, but also already identified to the installation administration proxy server as a candidate for software installation according to embodiments of the present invention.

Again with reference to FIG. 3: After validating (306) the install request (304), the method of FIG. 3 proceeds by identifying (308), by the installation administration proxy server (110), a trusted software installation server (114) to install software associated with the install request on the user computer. As discussed above, a software installation server installs software on the user computer (199) according to one or more software installation rules. Identifying (308) a trusted software installation server (114) may be carried out by retrieving from an installation server table that indexes installation servers by user agent IDs. A user agent may identify itself by user agent ID by including the user agent Id in the install request (304).

The method of FIG. 3 includes installing (310), by the trusted software installation server (114), software on the user computer (199) in accordance with software installation rules (312). Software installation rules are rules governing the installation of software for the user computer that are implemented by the software installation server that performs the software installation. Software installation rules are typically negotiated between the operator of entity of the federation that carries out the software installation and the operator of the user computer (199). Examples of software installation rules include rules instructing the software installation server to provide to a requesting user agent actual code for installation on the client computer, rules instructing the software installation server to provide to the client computer a password enabling the installation of code already available to a requesting user agent on the client computer, rules instructing the software installation server to provide a software upgrade to the requesting user agent on the client computer, and other rules that will occur to those of skill in the art.

Installing software on the user computer in accordance with software installation rules may be carried out by providing software code to the user agent, providing a password to the user agent to enable software installation on the client computer, providing a software upgrade to the user agent for upgrading software already installed on the client computer as well as other ways of installing software on the client computer that will occur to those of skill in the art.

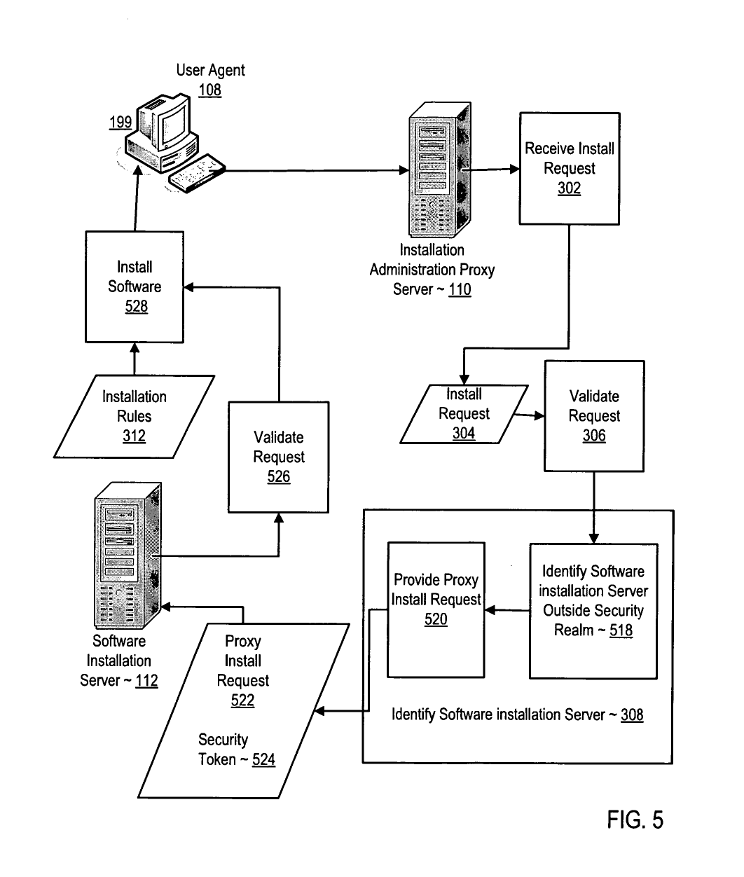

As discussed above, the trusted installation server identified by the installation administration proxy server may be in the same security realm as the installation administration proxy server and therefore require no additional procedures to broker trust between the installation administration proxy server and the software installation server. Alternatively, the trusted software installation server may reside outside the security realm of the installation administration proxy server but within the federation. For further explanation therefore, FIG. 5 sets forth an example of software installation within a federation according to embodiments of the present invention that includes identifying a software installation server outside the security realm of the installation administration proxy server. The method of FIG. 5 includes receiving (302), by an installation administration proxy server (110) from a user agent (108) installed on a user computer, an install request (304) and validating (306), by the installation administration proxy server (110), the install request (304).

The method of FIG. 5 includes identifying (308), by the installation administration proxy server (110), a trusted software installation server by identifying (518) a software installation server (112) outside the security realm of the installation administration proxy server (110). To broker trust outside the security realm of the installation administration proxy server, identifying (518) a software installation server (112) outside the security realm of the installation administration proxy server (110) according to the method of FIG. 5 also includes providing (520), by the software administration proxy server (110) to the software installation server (112) outside the security realm of the installation administration proxy server (110), a proxy install request (522) including a security token (524).

A proxy install (522) according to the method of FIG. 5 request is a message representing a request for software installation on a user computer (199) sent by the installation administration proxy server (110) to the software installation server (112). A proxy install request may comprise a request for software code to be installed on the user computer (199). A proxy install request may also comprise a request for a password enabling the installation of software already available to the user computer, a request for a software upgrade, or any other install request or combination of install requests that will occur to those of skill in the art.

The proxy install request (522) of FIG. 5 also includes a security token (524). As discussed above, WS-Federation provides for the use of security tokens to validate entities within the federation. A security token is typically implemented as an extension to a Simple Object Access Protocol (‘SOAP’) message and represents a collection of claims, which are declarations made by the entity providing the security token.

The method of FIG. 5 also includes validating (526), by the software installation server (112) outside the security realm of the installation administration proxy server (110), the proxy install request (522). The exemplary software installation server (112) of FIG. 5 validates the install request by validating a security token associated with the proxy install request. Validating a security token may be carried out by use of one or more security token services in accordance with the WS-Federation as discussed in more detail above with reference to FIG. 1.

The method of FIG. 5 also includes installing (528), by the software installation server (112) outside the security realm of the installation administration proxy server (110), software on user computer (199) in dependence upon software installation rules (312). As discussed above, software installation rules are rules governing the installation of software for the user computer that are implemented by the software installation server that performs the software installation. Examples of software installation rules include rules instructing the software installation server to provide to a requesting user agent actual code for installation on the client computer, rules instructing the software installation server to provide to the client computer a password enabling the installation of code already available to a requesting user agent on the client computer, rules instructing the software installation server to provide a software upgrade to the requesting user agent on the client computer, and other rules that will occur to those of skill in the art.

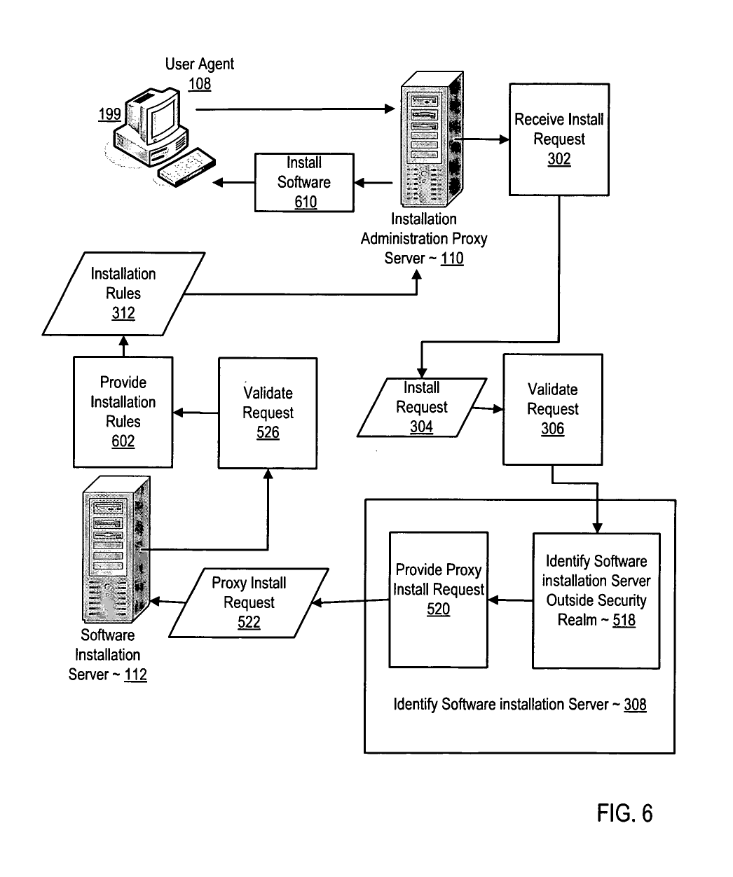

In the method of FIG. 5, the software installation server carried out the installation of software on the user computer. For further explanation, FIG. 6 sets forth a flow chart illustrating another exemplary method for software installation in a federation according to embodiments of the present invention wherein the software installation server does not install the software, but instead, provides software installation rules to the installation administration proxy server to carry out the installation of the software.

In a manner similar to the method discussed above with reference to FIG. 5, the method of FIG. 6 includes receiving (302), by an installation administration proxy server (110) from a user agent (108) installed on a user computer, an install request (304) and validating (306), by the installation administration proxy server (110), the install request (306). The method of FIG. 6 includes identifying (308), by the installation administration proxy server (110), a trusted software installation server by identifying (518) a software installation server (112) outside the security realm of the installation administration proxy server (110) and providing (520), by the software administration proxy server (110) to the software installation server (112) outside the security realm of the installation administration proxy server (110), a proxy install request (522) including a security token. The method of FIG. 6 also includes validating (526), by the software installation server (112) outside the security realm of the installation administration proxy server (110), the proxy install request (522).

The method of FIG. 6 includes providing (602), to installation administration proxy server (110) by the software installation server (112) outside the security realm of the installation administration proxy server (110), software installation rules (312). As discussed above, software installation rules are rules governing the installation of software for the user computer that are implemented by the software installation server that performs the software installation. In some embodiments, the software installation server (112) also provides to the installation administration proxy server (110) additional software code for installation according to the software installation rules.

The method of FIG. 6 also includes installing (610), by the installation administration proxy server (110), software associated with the install request (304) on user computer (199) in dependence upon the software installation rules (312). Installing (610), by the installation administration proxy server (110), software associated with the install request (304) on user computer (199) results in a single entity receiving the install request from the user agent and installing the software on the user computer in response to the install request. The method of FIG. 6 therefore provides a single point of contact to the user agent making the operations with the software installation server (112) transparent to the user agent.

In the examples of software installation within a federation described above an installation administration proxy server identifies a single trusted software installation server to install software associated with the install request on the user computer. This is for explanation and not for limitation. In some embodiments of the present invention identifying, by the installation administration proxy server, a trusted software installation server to install software associated with the install request on the user computer includes identifying a plurality of trusted software installation servers. Such embodiments often also include coordinating, by the installation administration proxy server, software installation among the plurality of trusted software installation servers. Coordinating software installation among the plurality of trusted software installation servers may be carried out by instructing each trusted software installation server to perform one or more actions such as to install software code on the user computer, to provide to a user agent a password enabling software already installed on the user computer, to provide to the installation administration proxy server software code for installation on the user computer, to provide to the installation administration proxy server a password enabling software already installed on the user computer, or any other way of coordinating software installation among the plurality of trusted software installation servers that will occur to those of skill in the art.

Exemplary embodiments of the present invention are described largely in the context of a fully functional computer system for software installation within a federation. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for software installation within a federation, the method comprising:
receiving, by an installation administration proxy server from a user agent installed on a user computer, an install request;
validating, by the installation administration proxy server, the install request including validating a security token associated with the install request;
identifying, by the installation administration proxy server, a trusted software;
installation server to install software associated with the install request on the user computer;
wherein the installation administration proxy server, the user agent, and the trusted software installation server comprise entities in the federation.

2. The method of claim 1 further comprising installing, by the trusted software installation server, software on the user computer in accordance with software installation rules.

3. The method of claim 2 wherein software installation rules further comprise one or more rules instructing the trusted software installation server to provide to a user agent a password enabling software installed on the user computer; and
installing, by the trusted software installation server, software on the user computer in accordance with software installation rules further comprises providing the password to the user agent.

4. The method of claim 2 wherein software installation rules further comprise one or more rules instructing the trusted software installation server to install software code on the user computer.

5. The method of claim 1 wherein validating, by the installation administration proxy server, the install request further comprises verifying a network location for the user agent.

6. The method of claim 1 wherein identifying, by the installation administration proxy server, a trusted software installation server further comprises:
identifying a software installation server outside the security realm of the installation administration proxy server; and
providing, by the software administration proxy server to the software installation server outside a security realm of the installation administration proxy server, a proxy install request including a security token.

7. The method of claim 6 further comprising:
validating, by the software installation server outside the security realm of the installation administration proxy server, the proxy install request; and
installing, by the software installation server outside the security realm of the installation administration proxy server, software on a user computer in dependence upon software installation rules.

8. The method of claim 6 further comprising:
validating, by the software installation server outside the security realm of the installation administration proxy server, the proxy install request;
providing, to installation administration proxy server by the software installation server outside the security realm of the installation administration proxy server, software installation rules; and
installing, by the installation administration proxy server, software associated with the install request on a user computer in dependence upon the software installation rules.

9. The method of claim 1 wherein the software administration proxy server and the user agent reside in different security realms.

10. The method of claim 1 wherein identifying, by the installation administration proxy server, a trusted software installation server to install software associated with the install request on the user computer includes identifying a plurality of trusted software installation servers; and
the method further comprises coordinating, by the installation administration proxy server, software installation among the plurality of trusted software installation servers.

11. An apparatus for software installation within a federation, the apparatus comprising a computer processor and a computer memory operatively coupled to the computer processor, the computer memory having disposed within it computer program instructions capable of:
receiving, from a user agent installed on a user computer, an install request;
validating the install request including validating a security token associated with the install request; and
identifying, a trusted software installation server to install software associated with the install request on the user computer.

12. The apparatus of claim 111 wherein the computer program instructions are capable of installing software on the user computer in accordance with software installation rules.

13. The apparatus of claim 11 wherein the computer program instructions are capable of verifying a network location for the user agent.

14. The apparatus of claim 11 wherein the computer program instructions are capable:
identifying a software installation server outside a security realm of the installation administration proxy server; and
providing to the software installation server outside the security realm of the installation administration proxy server a proxy install request including a security token.

15. A computer program product for software installation within a federation, the computer program product disposed upon a signal bearing medium, the computer program product comprising:
computer program instructions that receive, from a user agent installed on a user computer, an install request;
computer program instructions that validate the install request including computer program instructions that validate a security token associated with the install request;
computer program instructions that identify a trusted software installation server to install software associated with the install request on the user computer.

16. The computer program product of claim 15 wherein the signal bearing medium comprises a recordable medium.

17. The computer program product of claim 15 wherein the signal bearing medium comprises a transmission medium.

18. The computer program product of claim 15 further comprising computer program instructions that install software on the user computer in accordance with software installation rules.

19. The computer program product of claim 15 wherein computer program instructions that validate the install request further comprise computer program instructions that verify a network location for the user agent.

20. The computer program product of claim 15 wherein computer program instructions that identify a trusted software installation server further comprise:
computer program instructions that identify a software installation server outside a security realm of an installation administration proxy server; and
computer program instructions that provide to the software installation server outside the security realm of the installation administration proxy server a proxy install request including a security token.
